(19) United States
(12) Patent Application Publication
(10) Pub. No.: US 2012/0252613 A1
(43) Pub. Date: Oct. 4, 2012

(54) TREADLE-DRIVE ELLIPTICAL WHEEL TRANSMISSION WHEEL SERIES WITH PERIODICALLY VARIED SPEED RATIO

(76) Inventor: Tai-Her YANG, Dzan-Hwa (TW)

(21) Appl. No.: 13/087,450

(22) Filed: Apr. 15, 2011

Related U.S. Application Data
(63) Continuation-in-part of application No. 13/076,560, filed on Mar. 31, 2011, now abandoned.

(51) Int. Cl. F16H 9/02

(52) U.S. Cl. 474/71

(57) ABSTRACT

The present invention is structured by using one or both of an active wheel and a passive wheel to be constituted by a bimodal elliptical wheel, so that in the reciprocal treadle performed by the human's feet, when the feet input forces at different angles to an active wheel shaft combined on the active wheel through cranks and treadle shafts of the treadles, the active wheel forms different transmission speed ratios relative to the passive wheel according to the treadle angle.

### CROSS-REFERENCE TO RELATED APPLICATION

This application is a Continuation-In-Part of my patent application, Ser. No. 13/076,560, filed on Mar. 31, 2011.

### BACKGROUND OF THE INVENTION

(a) Field of the Invention

The present invention relates to a driving wheel series in which reciprocal treadle performed by human's two feet is transformed into rotation motions, especially one or both of an active wheel and a passive wheel is composed of a bimodal elliptical wheel, so in the reciprocal treadle performed by the rider's feet, a certain structure of treadle-drive elliptical wheel transmission wheel series with periodically varied speed ratio is constructed; and by the certain relation with respect to the treadling angle, the active wheel generates two speed ratio variations to the passive wheel in each rotation period; and by the reciprocal treadle performed by two feet, when the feet input forces at different angles to an active wheel shaft combined on the active wheel through cranks and treadle shafts of the treadles, the active wheel forms different transmission speed ratios relative to the passive wheel.

(b) Description of the Prior Art

A conventional treadle-drive transmission wheel series in which reciprocal treadle are performed by human's two feet is often utilized in an appliance wherein the reciprocal treadle performed by two feet is adopted for generating the rotation driving, such as a human treadling driven bicycle, a movement-assisting bicycle with human treadling drive and an electric motor for assistance, a fixed bicycle for exercising, a treadle-drive boat, a treadle-drive rotation type power generator, or a treadle-drive rotation fluid pump; in a treadle-drive transmission wheel series, chain wheels incorporate with chains, belt pulleys incorporate with belts, timing belt pulleys incorporate with timing belts, gears incorporate with tooth-shaped chains or gear transmission sets, so two feet can treadle a round active wheel for linking a passive wheel for driving a load; in the treadling, the feet can apply the most efficient treadling force to the active wheel with a certain angle displacement range, but the reciprocal treadle performed by human's feet and the rotation motion of the active wheel form a relation of simple harmonic motion, and due to the relation of simple harmonic motion, inefficient or low-efficient angle displacement ranges still exist and shall be improved.

### SUMMARY OF THE INVENTION

The present invention provides a treadle-drive elliptical wheel transmission wheel series with periodically varied speed ratio, which is a novel transmission wheel series utilizing the reciprocal treadle performed by human's two feet to transform into rotation motions, wherein one or both of an active wheel and a passive wheel is composed of a bimodal elliptical wheel, so that in the reciprocal treadle performed by the human's feet, when the feet input forces at different angles to an active wheel shaft combined on the active wheel through cranks and treadle shafts of the treadles, the active wheel forms different transmission speed ratios relative to the passive wheel according to the treadle angle.

### BRIEF DESCRIPTION OF THE DRAWINGS

FIG. 1 is a schematic view showing the speed ratio relation of the passive wheel and a mechanical driving angle formed through the active wheel shaft and the treadle shafts for treadling by two feet, according to a conventional round transmission wheel series.

FIG. 2 is a schematic view showing the speed ratio relation of the passive wheel and a mechanical driving angle formed through the active wheel and the treadle shafts of the two feet treadles, according to the bimodal elliptical transmission wheel series of the present invention.

FIG. 3 is a first schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at the position of upper stop directivity (a), wherein the active wheel is composed of the bimodal elliptical active wheel (112) and the passive wheel is composed of the round passive wheel (212), according to the bimodal elliptical transmission wheel series of the present invention.

FIG. 4 is a second schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 30 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

FIG. 5 is a third schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 60 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

FIG. 6 is a fourth schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 90 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

FIG. 7 is a fifth schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 120 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

FIG. 8 is a sixth schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 150 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

FIG. 9 is a schematic structural view showing the bimodal elliptical transmission wheel series of the present invention wherein the active wheel is a round wheel and the passive wheel is a bimodal elliptical passive wheel.

FIG. 10 is a schematic structural view showing the bimodal elliptical transmission wheel series of the present invention wherein the active wheel is a bimodal elliptical active wheel and the passive wheel is a bimodal elliptical passive wheel.

FIG. 11 is a schematic structural view showing the bimodal elliptical transmission wheel series of the present invention wherein the active wheel is a bimodal elliptical active gear and the passive wheel is a bimodal elliptical passive gear.

### DESCRIPTION OF MAIN COMPONENT SYMBOLS

100: Transmission belt
101: First crank
102: First treadle
103: First treadle shaft
111: Active wheel shaft
112: Bimodal elliptical active wheel
113: Round active wheel
114: Bimodal elliptical active gear
201: Second crank
202: Second treadle
203: Second treadle shaft
211: Passive wheel shaft
212: Round passive wheel
213: Bimodal elliptical passive wheel
214: Bimodal elliptical passive gear
301: Auxiliary wheel press helve
302: Auxiliary wheel prestressed spring
303: Auxiliary wheel press helve swing shaft
311: Auxiliary wheel shaft
312: Auxiliary wheel
800: Machine body
a: Upper stop directivity of b
b: Driving angle directivity of the first treadle shaft (103) or the second treadle shaft (203) to the active wheel shaft (111)

### DETAILED DESCRIPTION OF THE PREFERRED EMBODIMENTS

A conventional treadle-drive transmission wheel series in which reciprocal treadle are performed by human's two feet is often utilized in an appliance wherein the reciprocal treadle performed by two feet is adopted for generating the rotation driving, such as a human treadling driven bicycle, a movement-assisting bicycle with human treadling drive and an electric motor for assistance, a fixed bicycle for exercising, a treadle-drive boat, a treadle-drive rotation type power generator, or a treadle-drive rotation fluid pump; in a treadle-drive transmission wheel series, chain wheels incorporate with chains, belt pulleys incorporate with belts or metal bands, timing belt pulleys incorporate with timing belts, gears incorporate with tooth-shaped chains or gear transmission sets, so two feet can treadle a round active wheel for linking a passive wheel for driving a load, in the treadling, the feet can apply the most efficient treadling force to the active wheel with a certain angle displacement range, but the reciprocal treadle performed by human's feet and the rotation motion of the active wheel form a relation of simple harmonic motion, and due to the relation of simple harmonic motion, inefficient or low-efficient angle displacement ranges still exist and shall be improved.

The present invention provides a treadle-drive elliptical wheel transmission wheel series with periodically varied speed ratio, which is a novel transmission wheel series utilizing the reciprocal treadle performed by human's two feet to transform into rotation motions, wherein one or both of an active wheel and a passive wheel is composed of a bimodal elliptical wheel, so that in the reciprocal treadle performed by the human's feet, when the feet input forces at different angles to an active wheel shaft combined on the active wheel through cranks and treadle shafts of the treadles, the active wheel forms different transmission speed ratios relative to the passive wheel according to the treadle angle.

The present invention relates to a driving wheel series in which reciprocal treadle performed by human's two feet is transformed to rotation motions, especially one or both of an active wheel and a passive wheel is composed of a bimodal elliptical wheel, so in the reciprocal treadle performed by the rider's feet, a certain structure of treadle-drive elliptical wheel transmission wheel series with periodically varied speed ratio is constructed; and by the certain relation with respect to the treadling angle, the active wheel generates two speed ratio variations to the passive wheel in each rotation period; and the reciprocal treadle performed by two feet, when the feet input forces at different angles to an active wheel shaft combined on the active wheel through cranks and treadle shafts of the treadles, the active wheel forms different transmission speed ratios relative to the passive wheel.

According to the treadle-drive elliptical wheel transmission wheel series with periodically varied speed ratio of the present invention, the transmission speed ratio can achieve the maximum while close to the maximum treadling force angle, and the maximum transmission speed ratio is defined as the rotation speed angle displacement of the active wheel being capable of relatively transmitting a higher rotation speed to the passive wheel compared to other angle displacements during the whole period of the active wheel performing transmission to the passive wheel, the illustration is as following:

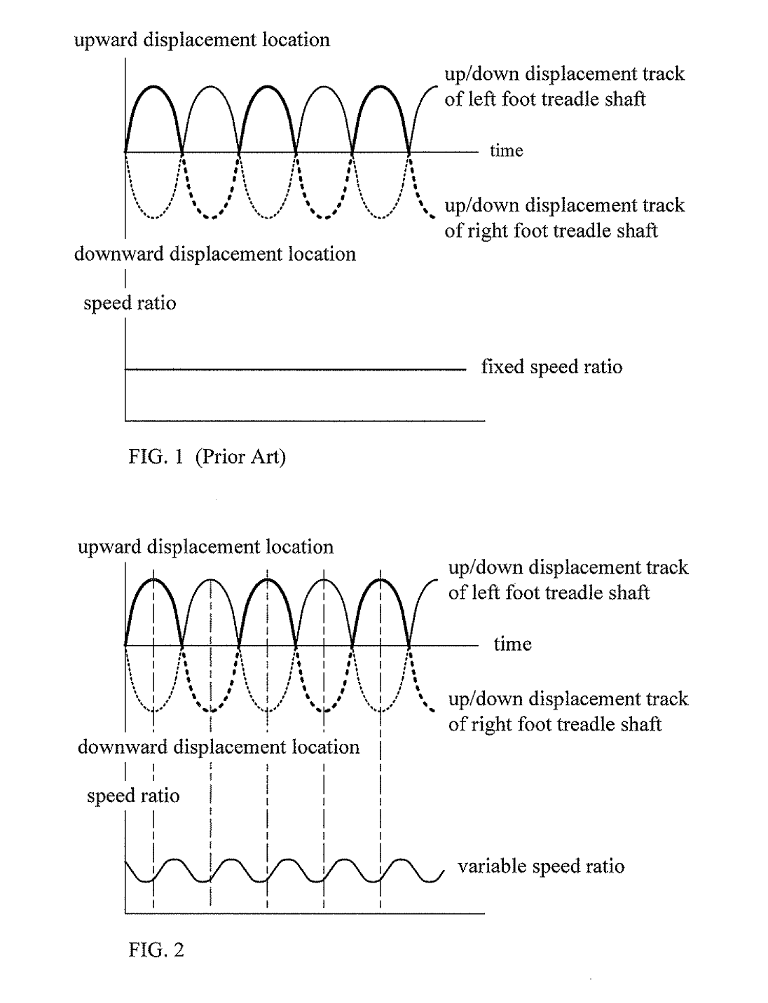

FIG. 1 is a schematic view showing the speed ratio relation of the passive wheel and a mechanical driving angle formed through the active wheel shaft and the treadle shafts for treadling by two feet, according to a conventional round transmission wheel series.

As shown in FIG. 1, when a rider uses his two feet to treadle for riding a bicycle, the treadle shafts respectively driven by the left foot and the right foot form a sine wave treadle track with 180 degree differentiation, wherein the right foot treadles with respect to the up/down displacement track of the right foot treadle shaft, and the left foot treadles with respect to the up/down displacement track of the left foot treadle shaft, and during the continuous treadling of the right foot and the left foot, the speed ratio of the active wheel and the passive wheel of the treadle-driven round transmission wheel series is the same.

FIG. 2 is a schematic view showing the speed ratio relation of the passive wheel and a mechanical driving angle formed through the active wheel and the treadle shafts of the two feet treadles, according to the bimodal elliptical transmission wheel series of the present invention.

As shown in FIG. 2, when a rider uses his two feet to treadle for riding a bicycle, the treadle shafts respectively driven by the left foot and the right foot form a sine wave shaped treadle track with 180 degree differentiation, wherein the right foot treadles with respect to the up/down displacement track of the first treadle shaft (103), and the left foot treadles with respect to the up/down displacement track of the second treadle shaft (203), during the continuous treadling of the right foot and the left foot, the speed ratio of the active wheel and the passive wheel of the treadle-drive elliptical transmission wheel series is defined through the mechanical angle differentiation relation of the mechanical angle position between a bimodal elliptical active wheel (112) and an active wheel shaft (111), and the mechanical angle position between a first treadle shaft (103) and a second treadle shaft (203) and the active wheel shaft (111), thereby the bimodal elliptical active wheel (112) periodically generates twice increase and decrease of the speed ratio to the passive wheel during each treadle rotation;

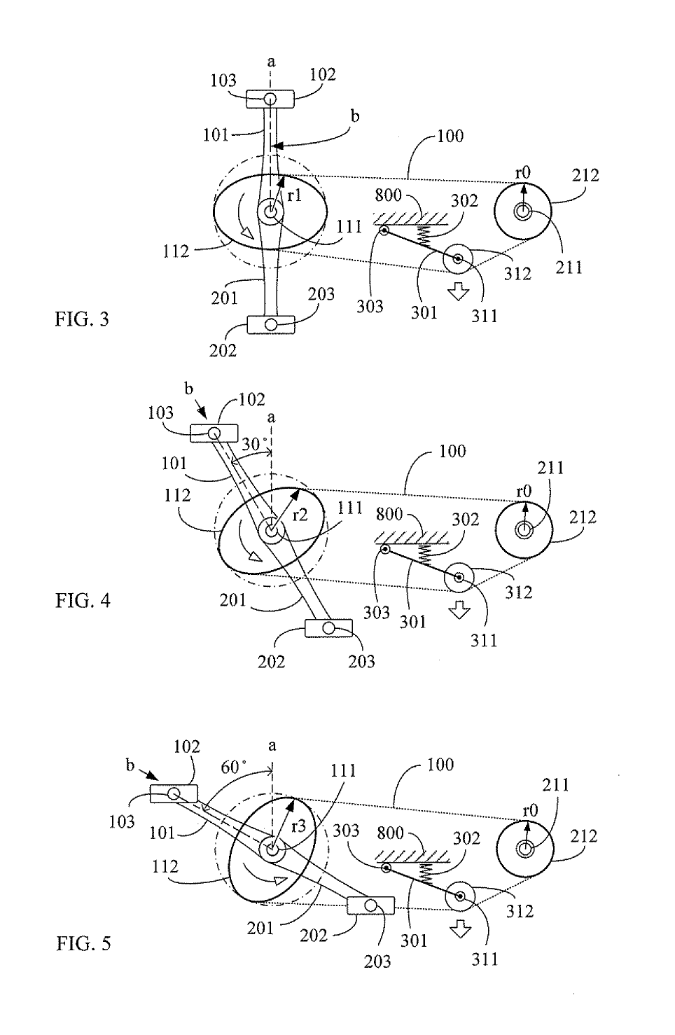

FIG. 3 is a first schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at the position of upper stop directivity (a), wherein the active wheel is composed of the bimodal elliptical active wheel (112) and the passive wheel is composed of the round passive wheel (212), according to the bimodal elliptical transmission wheel series of the present invention.

As shown in FIG. 3, it mainly consists of:
Transmission belt (100): a belt-shaped structure selected with respect to the wheel-shaped structures of the bimodal elliptical active wheel (112) and the round passive wheel (212) and an auxiliary wheel (312), which includes a chain, timing tooth-shaped belt or tooth-shaped belt, so as to be provided for the transmission operations between the bimodal active wheel (112) and the round passive wheel (212) and the auxiliary wheel (312);
Bimodal elliptical active wheel (112): combined with the active wheel shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), and the bimodal elliptical active wheel (112) is composed of a non-slidable chain wheel or timing tooth-shaped pulley, and wherein the mechanical angle position between the bimodal of the bimodal elliptic and the active wheel shaft (111) and the mechanical angle position between the first treadle shaft (103) and the second treadle shaft (203) and the active wheel shaft (111) form a certain mechanical angle differentiation relation;
Round passive wheel (212): composed of the same chain wheel or timing tooth-shaped pulley of which the bimodal elliptical active wheel (112) is composed, and is installed on the passive wheel shaft (211), and the round passive wheel is through the transmission belt (100) incorporating with the mentioned bimodal elliptical active wheel (112) and the round passive wheel (212) to be driven by the bimodal elliptical active wheel (112), and through the auxiliary wheel (312) to perform prestressed tightening to the periodical tightening/releasing alternation of the driven transmission belt;
Auxiliary wheel press helve (301): having one end coupled to a machine body (800) for swing motion through an auxiliary wheel press helve swing shaft (303), and the other end being installed with an auxiliary wheel shaft (311) for installing an auxiliary wheel (312), and an auxiliary wheel prestressed spring (302) is installed between the auxiliary wheel press helve (301) and the machine body (800) for generating an outward-expanding or inward-pressing prestressed pressure to the auxiliary wheel (312);
Auxiliary wheel (312): composed of the same chain wheel or timing tooth-shaped pulley of which the bimodal elliptical active wheel (112) and the round passive wheel (212) are composed, and provided for rotating on the auxiliary wheel shaft (311) and driven by the transmission belt (100), thereby through linked with the transmission belt (100) incorporating with the bimodal elliptical active wheel (112) and the round passive wheel (212), such as a chain or a timing tooth-shape pulley or a tooth-shaped chain, using the prestressed pressure applied to the auxiliary wheel press helve (301) from the auxiliary wheel prestressed spring (302) to compel the auxiliary wheel shaft (311) and the auxiliary wheel (312), so as to tighten the transmission belt (100);

In the transmission wheel series composed of the bimodal elliptical active wheel (112) serving as an active wheel, the round passive wheel (212) serving as a passive wheel and the installation of the auxiliary wheel (312), when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the bimodal elliptical active wheel (112) and the active wheel shaft (111), and the mechanical angle position between the first treadle shaft (103) and the second treadle shaft (203) and the active wheel shaft (111), and according to the set relation of the mechanical angle differentiations, the bimodal elliptical active wheel (112) periodically generates twice increase and decrease of the speed ratio to the round passive wheel (212) during each treadle rotation; for example, the mechanical angle differentiation relation of the mentioned bimodal elliptical active wheel (112) and the first treadle shaft (103) and the second treadle shaft (203) is selected to be set as, when treadling along the treadle direction, the mechanical angle directivity (b) of the first treadle shaft (103) or the second treadle shaft (203) to the active wheel shaft (111) passing the upper stop directivity (a) and keeping to treadle along the treadle direction within a 180 degree range, thereby the bimodal elliptical active wheel (112) to the round passive wheel (212) is in a transmission varied speed ratio status of tending to the maximum speed accelerating ratio or the minimum speed decelerating ratio; the speed ratio relation is shown in FIG. 2.;

As shown in FIG. 3, when the mechanical driving angle directivity (b) of the first treadle shaft (103) to the active wheel shaft (111) is at the position of the upper stop directivity (a), the bimodal elliptical active wheel (112) drives the transmission belt (100) at the location defined by a r₁ radius so as to link the round passive wheel (212) having a r₀ radius, thus a speed ratio of r₁:r₀ is formed;

FIG. 4 is a second schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 30 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

As shown in FIG. 4, when the mechanical driving angle directivity (b) of the first treadle shaft (103) to the active wheel shaft (111) is displaced by 30 degree along the rotation direction relative to the upper stop directivity (a), the bimodal elliptical active wheel (112) drives the transmission belt (100) at the location defined by a r₂ radius so as to link the round passive wheel (212) having a r₀ radius, thus a speed ratio of r₂:r₀ is formed;

FIG. 5 is a third schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 60 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

As shown in FIG. 5, when the mechanical driving angle directivity (b) of the first treadle shaft (103) to the active wheel shaft (111) is displaced by 60 degree along the rotation direction relative to the upper stop directivity (a), the bimodal elliptical active wheel (112) drives the transmission belt (100) at the location defined by a r₃ radius so as to link the round passive wheel (212) having a r₀ radius, thus a speed ratio of r₃:r₀ is formed;

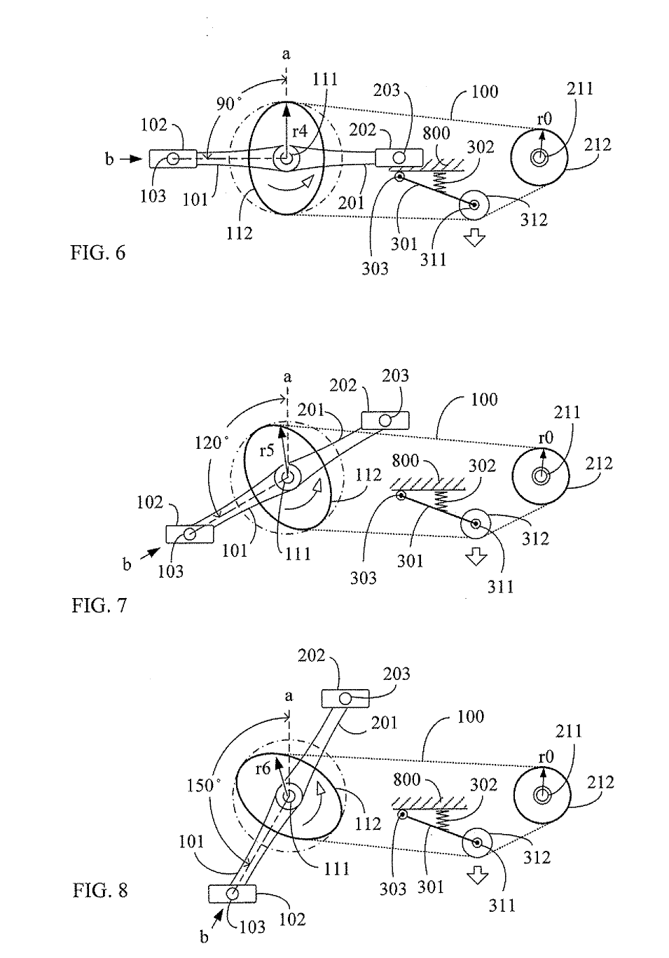

FIG. 6 is a fourth schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 90 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

As shown in FIG. 6, when the mechanical driving angle directivity (b) of the first treadle shaft (103) to the active wheel shaft (111) is displaced by 90 degree along the rotation direction relative to the upper stop directivity (a), the bimodal elliptical active wheel (112) drives the transmission belt (100) at the location defined by a r₄ radius so as to link the round passive wheel (212) having a r₀ radius, thus a speed ratio of r₄:r₀ is formed;

FIG. 7 is a fifth schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 120 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

As shown in FIG. 7, when the mechanical driving angle directivity (b) of the first treadle shaft (103) to the active wheel shaft (111) is displaced by 120 degree along the rotation direction relative to the upper stop directivity (a), the bimodal elliptical active wheel (112) drives the transmission belt (100) at the location defined by a r₅ radius so as to link the round passive wheel (212) having a r₀ radius, thus a speed ratio of r₅:r₀ is formed;

FIG. 8 is a sixth schematic view showing the transmission speed ratio of the bimodal elliptical active wheel (112) and the round passive wheel (212) when the mechanical driving angle directivity (b) of the first treadle shaft (103) or the second treadle shaft (203) to the active wheel shaft (111) is at a location defined by displacing 150 degree along the rotation direction relative to the upper stop directivity (a), wherein the active wheel is composed of the bimodal elliptical active wheel (112) and the passive wheel is composed of the round passive wheel (212), according to the bimodal elliptical transmission wheel series shown in FIG. 3.

As shown in FIG. 8, when the mechanical driving angle directivity (b) of the first treadle shaft (103) to the active wheel shaft (111) is displaced by 150 degree along the rotation direction relative to the upper stop directivity (a), the bimodal elliptical active wheel (112) drives the transmission belt (100) at the location defined by a r₆ radius so as to link the round passive wheel (212) having a r₀ radius, thus a speed ratio of r₆:r₀ is formed;

The second treadle shaft (203) driving the active wheel shaft (111), and the operation of the round passive wheel (212) and the passive wheel shaft (211) being linked through the bimodal elliptical active wheel (112) and the transmission belt (100) are the same as the mentioned first treadle shaft (103) driving the active wheel shaft (111), and the operation of the round passive wheel (212) and the passive wheel shaft (211) being linked through the bimodal elliptical active wheel (112) and the transmission belt (100).

According to the mentioned embodiment shown in FIG. 3, the treadle-drive elliptical wheel transmission wheel series with periodically varied speed ratio composed of the bimodal elliptical active wheel (112) and the round passive wheel (212) can also be composed by slidable pulleys and transmission belts, because the round passive wheel (212) is a round wheel, the property thereof of forming different speed ratios would be not affected by sliding;

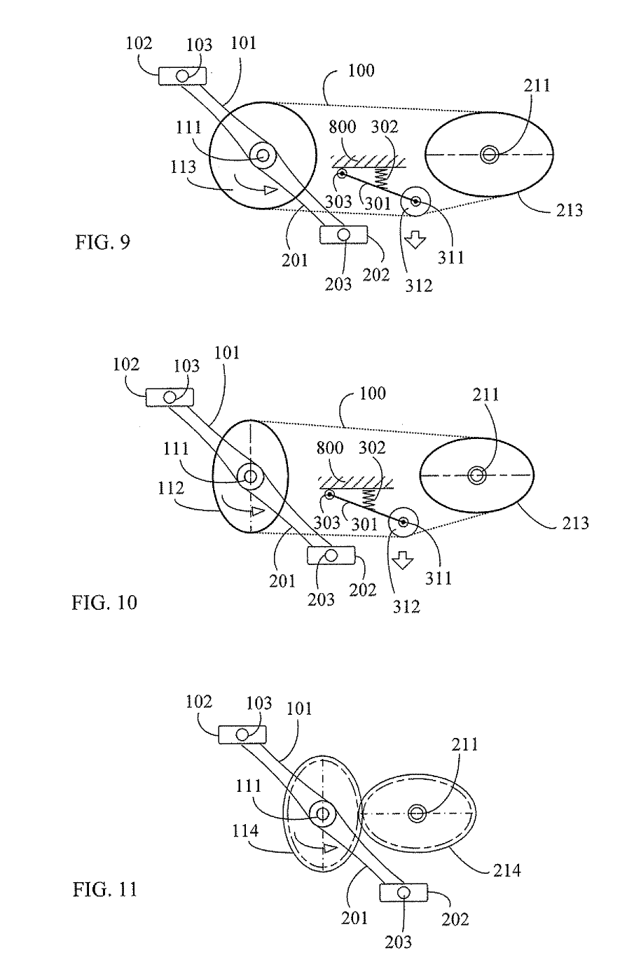

FIG. 9 is a schematic structural view showing the bimodal elliptical transmission wheel series of the present invention wherein the active wheel is a round wheel and the passive wheel is a bimodal elliptical passive wheel.

According to the treadle-drive elliptical wheel transmission wheel series with periodically varied speed ratio of the present invention, the bimodal elliptical passive wheel (213) can be composed of the same chain wheel or timing tooth-shaped pulley of which the round active wheel (113) is composed; the transmission belt (100) is a belt-shaped structure selected with respect to the wheel-shaped structures of the round active wheel (113) and the bimodal elliptical passive wheel (213) and the auxiliary wheel (312), which includes a chain, timing tooth-shaped belt, tooth-shaped belt, so as to be provided for the transmission operations between the round active wheel (113), the bimodal elliptical passive wheel (213) and the auxiliary wheel (312);

As shown in FIG. 9, it mainly consists of:
Transmission belt (100): a belt-shaped structure selected with respect to the wheel-shaped structures of the bimodal elliptical active wheel (112) and the round passive wheel (212) and an auxiliary wheel (312), which includes a chain, timing tooth-shaped belt or tooth-shaped chain, so as to be provided for the transmission operations between the bimodal active wheel (112) and the round passive wheel (212) and the auxiliary wheel (312);
Round active wheel (113): combined with the active wheel shaft (111), and the two sides of the active wheel shaft (111) are respectively combined with a first crank (101) and a second crank (201), wherein the first crank (101) is installed with a first treadle shaft (103) for being provided with a first treadle (102), and the second crank (201) is installed with a second treadle shaft (203) for being provided with a second treadle (202), and the round active wheel (113) is composed of a non-slidable chain wheel or timing tooth-shaped pulley;
Bimodal elliptical passive wheel (213): composed of a bimodal elliptical chain wheel or timing tooth-shaped pulley having the same circumference as the round active wheel (113), and installed on the passive wheel shaft (211), and the passive wheel is through the transmission belt (100) incorporating with the mentioned round active wheel (113) and the bimodal elliptical passive wheel (213) to be driven by the round active wheel (113), and through the auxiliary wheel (312) to perform prestressed tightening to the periodical tightening/releasing alternation of the driven transmission belt (100);
wherein the mechanical angle position between the bimodal of the bimodal elliptic and the passive wheel shaft (211), and the mechanical angle position between the round active wheel (113) and the first treadle shaft (103) and the second treadle shaft (203) and the active wheel shaft (111) form a certain mechanical angle differentiation relation;
Auxiliary wheel press helve (301): having one end coupled to a machine body (800) for swing motion through an auxiliary wheel press helve swing shaft (303), and the other end being installed with an auxiliary wheel shaft (311) for installing an auxiliary wheel (312), and an auxiliary wheel prestressed spring (302) is installed between the auxiliary wheel press helve (301) and the machine body (800) for generating an outward-expanding or inward-pressing prestressed pressure to the auxiliary wheel (312);
Auxiliary wheel (312): composed of the same chain wheel or timing tooth-shaped pulley of which the round active wheel (113) and the bimodal elliptical passive wheel (213) are composed, and provided for rotating on the auxiliary wheel shaft (311) and driven by the transmission belt (100), thereby through linked with the transmission belt (100) incorporating with the round active wheel (113) and the bimodal elliptical passive wheel (213), such as a chain or a timing tooth-shape pulley or a tooth-shaped chain, to utilize the prestressed pressure applied to the auxiliary wheel press helve (301) from the auxiliary wheel prestressed spring (302) to compel the auxiliary wheel shaft (311) and the auxiliary wheel (312), so as to tighten the transmission belt (100);

In the transmission wheel series composed of the round active wheel (113) serving as an active wheel, the bimodal elliptical passive wheel (213) serving as a passive wheel and the installation of the auxiliary wheel (312), when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the first treadle shaft (103) and the second treadle shaft (203) and the active wheel shaft (111), and through the transmission belt (100) the set mechanical angle position between the bimodal elliptical passive wheel (213) and the passive wheel shaft (211), thereby the round active wheel (113) periodically generates twice increase and decrease of the speed ratio to the bimodal elliptical passive wheel (213) during each treadle rotation; for example the mechanical angle differentiation relation of the mentioned round active wheel (113) and the first treadle shaft (103) and the second treadle shaft (203) is selected to be set as, when treadling along the treadle direction, the first treadle shaft (103) or the second treadle shaft (203) passing the upper stop and keeping to treadle along the treadle direction within a 180 degree range, thereby the round active wheel (113) to the bimodal elliptical passive wheel (213) is in a transmission varied speed ratio status of tending to the maximum speed accelerating ratio or the minimum speed decelerating ratio; the speed ratio relation is shown in FIG. 2.;

FIG. 10 is a schematic structural view showing the bimodal elliptical transmission wheel series of the present invention wherein the active wheel is a bimodal elliptical active wheel and the passive wheel is a bimodal elliptical passive wheel.

According to the treadle-drive elliptical wheel transmission wheel series with periodically varied speed ratio of the present invention, the bimodal elliptical passive wheel (213) can be composed of the same elliptical chain wheel or timing tooth-shaped belt of which the bimodal elliptical active wheel (112) is composed; the transmission belt (100) is a belt-shaped structure selected with respect to the wheel-shaped structures of the bimodal elliptical active wheel (112) and the bimodal elliptical passive wheel (213) and the auxiliary wheel (312), which includes a chain, timing tooth-shaped belt, tooth-shaped belt, so as to be provided for the transmission operations between the bimodal elliptical active wheel (112), the bimodal elliptical passive wheel (213) and the auxiliary wheel (312);

As shown in FIG. 10, it mainly consists of:
Transmission belt (100): a belt-shaped structure selected with respect to the wheel-shaped structures of the bimodal elliptical active wheel (112) and the bimodal elliptical passive wheel (213) and an auxiliary wheel (312), which includes a chain, timing tooth-shaped belt or tooth-shaped chain, so as to be provided for the transmission operations between the bimodal active wheel (112) and the bimodal elliptical passive wheel (213) and the auxiliary wheel (312);
Bimodal elliptical active wheel (112): combined with the active wheel lo shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), and the bimodal elliptical active wheel (112) is composed of a non-slidable chain wheel or timing tooth-shaped pulley, and wherein the mechanical angle position between the bimodal of the bimodal elliptic and the active wheel shaft (111) and the mechanical angle position between the first treadle shaft (103) and the second treadle shaft (203) and the active wheel shaft (111) form a certain mechanical angle differentiation relation;
Bimodal elliptical passive wheel (213): composed of the bimodal elliptical chain wheel or timing tooth-shaped pulley having the same shape and the same size as the bimodal elliptical active wheel (112), and is installed on the passive wheel shaft (211) and forms a 90 degree mechanical angle differentiation relative to the bimodal elliptical active wheel (112), and through the transmission belt (100) for transmission and connection, so as to be driven by the bimodal elliptical active wheel (211), and through the auxiliary wheel (312) to perform prestressed tightening to the tightening/releasing alternation of the driven transmission belt (100);
Auxiliary wheel press helve (301): having one end coupled to a machine body (800) for swing motion through an auxiliary wheel press helve swing shaft (303), and the other end being installed with an auxiliary wheel shaft (311) for installing an auxiliary wheel (312), and an auxiliary wheel prestressed spring (302) is installed between the auxiliary wheel press helve (301) and the machine body (800) for generating an outward-expanding or inward-pressing prestressed pressure to the auxiliary wheel (312);
Auxiliary wheel (312): composed of the same chain wheel or timing tooth-shaped pulley of which the bimodal elliptical active wheel (112) and the bimodal elliptical passive wheel (213) are composed, and provided for rotating on the auxiliary wheel shaft (311) and driven by the transmission belt (100), thereby through linked with the transmission belt (100) incorporating with the bimodal elliptical active wheel (112) and the bimodal elliptical passive wheel (213), such as a chain or timing tooth-shape pulley or tooth-shaped chain, to use the prestressed pressure applied to the auxiliary wheel press helve (301) from the auxiliary wheel prestressed spring (302) to compel the auxiliary wheel shaft (311) and the auxiliary wheel (312), so as to tighten the transmission belt (100);

In the transmission wheel series composed of the bimodal elliptical active wheel (112) serving as an active wheel, the bimodal elliptical passive wheel (213) serving as a passive wheel and the installation of the auxiliary wheel (312), when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the bimodal elliptical active wheel (112) and the active wheel shaft (111), and the mechanical angle position between the first treadle shaft (103) and the second treadle shaft (203) and the active wheel shaft (111), and through the transmission belt (100) the set mechanical angle position between the bimodal elliptical passive wheel (213) and the passive wheel shaft (211), so the bimodal elliptical active wheel (112) periodically generates twice increase and decrease of the speed ratio to the bimodal elliptical passive wheel (213)during each treadle rotation; for example, the mechanical angle differentiation relation of the mentioned bimodal elliptical active wheel (112) and the first treadle shaft (103) and the second treadle shaft (203) is selected to be set as, when treadling along the treadle direction, the first treadle shaft (103) or the second treadle shaft (203) passing the upper stop and keeping to treadle along the treadle direction within a 90 degree range, thereby the bimodal elliptical active wheel (112) to the bimodal elliptical passive wheel (213) is in a transmission varied speed ratio status of tending to the maximum speed accelerating ratio or the minimum speed decelerating ratio; the speed ratio relation is shown in FIG. 2.

FIG. 11 is a schematic structural view showing the bimodal elliptical transmission wheel series of the present invention wherein the active wheel is a bimodal elliptical active gear and the passive wheel is a bimodal elliptical passive gear.

As shown in FIG. 11, it mainly consists of:
Bimodal elliptical active gear (114): combined with the active wheel shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), the bimodal elliptical active gear (114) is composed of a gear, and wherein the mechanical angle position between the bimodal of the bimodal elliptic and the active wheel shaft (111) and the mechanical angle position between the first treadle shaft (103) and the second treadle shaft (203) and the active wheel shaft (111) form a certain mechanical angle differentiation relation;
Bimodal elliptical passive gear (214): constituted by a bimodal elliptical gear having the same shape and the same size as the bimodal elliptical active gear (114), and engaged with the bimodal elliptical active gear (114) at a 90 degree mechanical angel differentiation for being driven by the bimodal elliptical active gear (114);

In the transmission wheel series composed of the bimodal elliptical active gear (114) serving as an active wheel, the bimodal elliptical passive gear (214) serving as a passive wheel and the above two components are engaged at a 90 degree mechanical angle differentiation, when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the bimodal elliptical active gear (114) and the active wheel shaft (111) and the mechanical angle position between the first treadle shaft (103) and the second treadle shaft (203) and the active wheel shaft (111), and according to the set relation of the mechanical angle differentiations, the bimodal elliptical active gear (114) periodically generates twice increase and decrease of the speed ratio to the bimodal elliptical passive gear (214) during each treadle rotation; for example, the mechanical angle differentiation relation of the mentioned bimodal elliptical active gear (114) and the first treadle shaft (103) and the second treadle shaft (203) is selected to be set as, when treadling along the treadle direction, the first treadle shaft (103) or the second treadle shaft (203) passing the upper stop and keeping to treadle along the treadle direction within a 180 degree range, thereby the bimodal elliptical active gear (114) to the bimodal elliptical passive gear (214) is in a transmission varied speed ratio status of tending to the maximum speed accelerating ratio or the minimum speed decelerating ratio; the speed ratio relation is shown in FIG. 2.

1. A treadle-drive elliptical wheel transmission wheel series with periodically varied speed ratio, in which reciprocal treadle performed by human's two feet is transformed to rotation motions, especially one or both of an active wheel and a passive wheel is composed of a bimodal elliptical wheel, so in the reciprocal treadle performed by the rider's feet, a certain structure of treadle-drive elliptical wheel transmission wheel series with periodically varied speed ratio is constructed; and by the certain relation with respect to the treadling angle, the active wheel generates two speed ratio variations to the passive wheel in each rotation period; and by the reciprocal treadle performed by two feet, when the feet input forces at different angles to an active wheel shaft combined on the active wheel through cranks and treadle shafts of the treadles, the active wheel forms different transmission speed ratios relative to the passive wheel.

2. A treadle-drive elliptical wheel transmission wheel series with periodically varied speed ratio claimed by claim 1, wherein the maximum transmission speed ratio is selected to set as close to the maximum treadling force angle, and the maximum transmission speed ratio is defined as the rotation speed angle displacement of the active wheel being capable of relatively transmitting a higher rotation speed to the passive wheel compared to other angle displacements during the whole period of the active wheel performing transmission to the passive wheel.

3. A treadle-drive elliptical wheel transmission wheel series with periodically varied speed ratio claimed by claim 1, wherein the active wheel is composed of the bimodal elliptical active wheel (112) and the passive wheel is composed of the round passive wheel (212), which mainly consist of:
Transmission belt (100): a belt-shaped structure selected with respect to the wheel-shaped structures of the bimodal elliptical active wheel (112) and the round passive wheel (212) and an auxiliary wheel (312), which includes a chain, timing tooth-shaped belt or tooth-shaped belt, so as to be provided for the transmission operations between the bimodal active wheel (112) and the round passive wheel (212) and the auxiliary wheel (312);
Bimodal elliptical active wheel (112): combined with the active wheel shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), and the bimodal elliptical active wheel (112) is composed of a non-slidable chain wheel or timing tooth-shaped pulley, and wherein the mechanical angle position between the bimodal of the bimodal elliptic and the active wheel shaft (111) and the mechanical angle position between the first treadle shaft (103) and the second treadle shaft (203) and the active wheel shaft (111) form a certain mechanical angle differentiation relation;
Round passive wheel (212): composed, of the same chain wheel or timing tooth-shaped pulley of which the bimodal elliptical active wheel (112) is composed, and is installed on the passive wheel shaft (211), and the round passive wheel is through the transmission belt (100) incorporating with the mentioned bimodal elliptical active wheel (112) and the round passive wheel (212) to be driven by the bimodal elliptical active wheel (112), and through the auxiliary wheel (312) to perform prestressed tightening to the periodical tightening/releasing alternation of the driven transmission belt;
Auxiliary wheel press helve (301): having one end coupled to a machine body (800) for swing motion through an auxiliary wheel press helve swing shaft (303), and the other end being installed with an auxiliary wheel shaft (311) for installing an auxiliary wheel (312), and an auxiliary wheel prestressed spring (302) is installed between the auxiliary wheel press helve (301) and the machine body (800) for generating an outward-expanding or inward-pressing prestressed pressure to the auxiliary wheel (312);
Auxiliary wheel (312): composed of the same chain wheel or timing tooth-shaped pulley of which the bimodal elliptical active wheel (112) and the round passive wheel (212) are composed, and provided for rotating on the auxiliary wheel shaft (311) and driven by the transmission belt (100), thereby through linked with the transmission belt (100) incorporating with the bimodal elliptical active wheel (112) and the round passive wheel (212), such as a chain or a timing tooth-shape pulley or a tooth-shaped chain, using the prestressed pressure applied to the auxiliary wheel press helve (301) from the auxiliary wheel prestressed spring (302) to compel the auxiliary wheel shaft (311) and the auxiliary wheel (312), so as to tighten the transmission belt (100);
In the transmission wheel series composed of the bimodal elliptical active wheel (112) serving as an active wheel, the round passive wheel (212) serving as a passive wheel and the installation of the auxiliary wheel (312), when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the bimodal elliptical active wheel (112) and the active wheel shaft (111), and the mechanical angle position between the first treadle shaft (103) and the second treadle shaft (203) and the active wheel shaft (111), and according to the set relation of the mechanical angle differentiations, the bimodal elliptical active wheel (112) periodically generates twice increase and decrease of the speed ratio to the round passive wheel (212) during each treadle rotation.

4. A treadle-drive elliptical wheel transmission wheel series with periodically varied speed ratio claimed by claim 3, wherein the mechanical angle differentiation relation of the mentioned bimodal elliptical active wheel (112) and the first treadle shaft (103) and the second treadle shaft (203) is selected to be set as, when treadling along the treadle direction, the mechanical angle directivity (b) of the first treadle shaft (103) or the second treadle shaft (203) to the active wheel shaft (111) passing the upper stop directivity (a) and keeping to treadle along the treadle direction within a 180 degree range, thereby the bimodal elliptical active wheel (112) to the round passive wheel (212) is in a transmission varied speed ratio status of tending to the maximum speed accelerating ratio or the minimum speed decelerating ratio.

5. A treadle-drive elliptical wheel transmission wheel series with periodically varied speed ratio claimed by claim 1, wherein the active wheel is a round wheel and the passive wheel is a bimodal elliptical passive wheel, which mainly consist of:
Transmission belt (100): a belt-shaped structure selected with respect to the wheel-shaped structures of the bimodal elliptical active wheel (112) and the round passive wheel (212) and an auxiliary wheel (312), which includes a chain, timing tooth-shaped belt or tooth-shaped chain, so as to be provided for the transmission operations between the bimodal active wheel (112) and the round passive wheel (212) and the auxiliary wheel (312);
Round active wheel (113): combined with the active wheel shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), and the round active wheel (113) is composed of a non-slidable chain wheel or timing tooth-shaped pulley;
Bimodal elliptical passive wheel (213): composed of a bimodal elliptical chain wheel or timing tooth-shaped pulley having the same circumference as the round active wheel (113), and is installed on the passive wheel shaft (211), and the passive wheel is through the transmission belt (100) incorporating with the mentioned round active wheel (113) and the bimodal elliptical passive wheel (213) to be driven by the round active wheel (113), and through the auxiliary wheel (312) to perform prestressed tightening to the periodical tightening/releasing alternation of the driven transmission belt (100);
wherein the mechanical angle position between the bimodal of the bimodal elliptic and the passive wheel shaft (211), and the mechanical angle position between the round active wheel (113) and the first treadle shaft (103) and the second treadle shaft (203) and the active wheel shaft (111) form a certain mechanical angle differentiation relation;
Auxiliary wheel press helve (301): having one end coupled to a machine body (800) for swing motion through an auxiliary wheel press helve swing shaft (303), and the other end being installed with an auxiliary wheel shaft (311) for installing an auxiliary wheel (312), and an auxiliary wheel prestressed spring (302) is installed between the auxiliary wheel press helve (301) and the machine body (800) for generating an outward-expanding or inward-pressing prestressed pressure to the auxiliary wheel (312);
Auxiliary wheel (312): composed of the same chain wheel or timing tooth-shaped pulley of which the round active wheel (113) and the bimodal elliptical passive wheel (213) are composed, and provided for rotating on the auxiliary wheel shaft (311) and driven by the transmission belt (100), thereby through linked with the transmission belt (100) incorporating with the round active wheel (113) and the bimodal elliptical passive wheel (213), such as a chain or a timing tooth-shape pulley or a tooth-shaped chain, to use the prestressed pressure applied to the auxiliary wheel press helve (301) from the auxiliary wheel prestressed spring (302) to compel the auxiliary wheel shaft (311) and the auxiliary wheel (312), so as to tighten the transmission belt (100);
In the transmission wheel series composed of the round active wheel (113) serving as an active wheel, the bimodal elliptical passive wheel (213) serving as a passive wheel and the installation of the auxiliary wheel (312), when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the first treadle shaft (103) and the second treadle shaft (203) and the active wheel shaft (111), and through the transmission belt (100) the mechanical angle position between the bimodal elliptical passive wheel (213) and the passive wheel shaft (211), thereby the round active wheel (113) periodically generates twice increase and decrease of the speed ratio to the bimodal elliptical passive wheel (213) during each treadle rotation.

6. A treadle-drive elliptical wheel transmission wheel series with periodically varied speed ratio claimed by claim 5, wherein the mechanical angle differentiation relation of the mentioned round active wheel (113) and the first treadle shaft (103) and the second treadle shaft (203) is selected to be set as, when treadling along the treadle direction, the first treadle shaft (103) or the second treadle shaft (203) passing the upper stop and keeping to treadle along the treadle direction within a 180 degree range, thereby the round active wheel (113) to the bimodal elliptical passive wheel (213) is in a transmission varied speed ratio status of tending to the maximum speed accelerating ratio or the minimum speed decelerating ratio.

7. A treadle-drive elliptical wheel transmission wheel series with periodically varied speed ratio claimed by claim 5, wherein the bimodal elliptical passive wheel (213) can be composed of the same chain wheel or timing tooth-shaped pulley of which the round active wheel (113) is composed; the transmission belt (100) is a belt-shaped structure selected with respect to the wheel-shaped structures of the round active wheel (113) and the bimodal elliptical passive wheel (213) and the auxiliary wheel (312), which includes a chain, timing tooth-shaped belt, tooth-shaped belt, so as to be provided for the transmission operations between the round active wheel (113), the bimodal elliptical passive wheel (213) and the auxiliary wheel (312).

8. A treadle-drive elliptical wheel transmission wheel series with periodically varied speed ratio claimed by claim 1, wherein the active wheel is a bimodal elliptical active wheel and the passive wheel is a bimodal elliptical passive wheel, which mainly consists of:
Transmission belt (100): a belt-shaped structure selected with respect to the wheel-shaped structures of the bimodal elliptical active wheel (112) and the bimodal elliptical passive wheel (213) and an auxiliary wheel (312), which includes a chain, timing tooth-shaped belt or tooth-shaped chain, so as to be provided for the transmission operations between the bimodal active wheel (112) and the bimodal elliptical passive wheel (213) and the auxiliary wheel (312);
Bimodal elliptical active wheel (112): combined with the active wheel shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), and the bimodal elliptical active wheel (112) is composed of a non-slidable chain wheel or timing tooth-shaped pulley, and wherein the mechanical angle position between the bimodal of the bimodal elliptic and the active wheel shaft (111) and the mechanical angle position between the first treadle shaft (103) and the second treadle shaft (203) and the active wheel shaft (111) form a certain mechanical angle differentiation relation;
Bimodal elliptical passive wheel (213): composed of the bimodal elliptical chain wheel or timing tooth-shaped pulley having the same shape and the same size as the bimodal elliptical active wheel (112), and is installed on the passive wheel shaft (211) and forms a 90 degree mechanical angle differentiation relative to the bimodal elliptical active wheel (112), and through the transmission belt (100) for transmission and connection, so as to be driven by the bimodal elliptical active wheel (211), and through the auxiliary wheel (312) to perform prestressed tightening to the tightening/releasing alternation of the driven transmission belt (100);
Auxiliary wheel press helve (301): having one end coupled to a machine body (800) for swing motion through an auxiliary wheel press helve swing shaft (303), and the other end being installed with an auxiliary wheel shaft (311) for installing an auxiliary wheel (312), and an auxiliary wheel prestressed spring (302) is installed between the auxiliary wheel press helve (301) and the machine body (800) for generating an outward-expanding or inward-pressing prestressed pressure to the auxiliary wheel (312);
Auxiliary wheel (312): composed of the same chain wheel or timing tooth-shaped pulley of which the bimodal elliptical active wheel (112) and the bimodal elliptical passive wheel (213) are composed, and provided for rotating on the auxiliary wheel shaft (311) and driven by the transmission belt (100), thereby through linked with the transmission belt (100) incorporating with the bimodal elliptical active wheel (112) and the bimodal elliptical passive wheel (213), such as a chain or timing tooth-shape pulley or tooth-shaped chain, to use the prestressed pressure applied to the auxiliary wheel press helve (301) from the auxiliary wheel prestressed spring (302) to compel the auxiliary wheel shaft (311) and the auxiliary wheel (312), so as to tighten the transmission belt (100);
In the transmission wheel series composed of the bimodal elliptical active wheel (112) serving as an active wheel, the bimodal elliptical passive wheel (213) serving as a passive wheel and the installation of the auxiliary wheel (312), when a human uprightly treadle to ride a bicycle, the right foot and the left foot follow a simple harmonic motion to form a sine wave treadle track with 180 degree differentiation, wherein the right foot treadles with respect to the up/down displacement track of the first treadle shaft (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the bimodal elliptical active wheel (112) and the active wheel shaft (111), and the mechanical angle position between the first treadle shaft (103) and the second treadle shaft (203) and the active wheel shaft (111), and through the transmission belt (100) the set mechanical angle position between the bimodal elliptical passive wheel (213) and the passive wheel shaft (211), so the bimodal elliptical active wheel (112) periodically generates twice increase and decrease of the speed ratio to the bimodal elliptical passive wheel (213) during each treadle rotation.

9. A treadle-drive elliptical wheel transmission wheel series with periodically varied speed ratio claimed by claim 8, wherein the mechanical angle differentiation relation of the mentioned bimodal elliptical active wheel (112) and the first treadle shaft (103) and the second treadle shaft (203) is selected to be set as, when treadling along the treadle direction, the first treadle shaft (103) or the second treadle shaft (203) passing the upper stop and keeping to treadle along the treadle direction within a 90 degree range, thereby the bimodal elliptical active wheel (112) to the bimodal elliptical passive wheel (213) is in a transmission varied speed ratio status of tending to the maximum speed accelerating ratio or the minimum speed decelerating ratio.

10. A treadle-drive elliptical wheel transmission wheel series with periodically varied speed ratio claimed by claim 8, wherein the bimodal elliptical passive wheel (213) can be composed of the same elliptical chain wheel or timing tooth-shaped belt of which the bimodal elliptical active wheel (112) is composed; the transmission belt (100) is a belt-shaped structure selected with respect to the wheel-shaped structures of the bimodal elliptical active wheel (112) and the bimodal elliptical passive wheel (213) and the auxiliary wheel (312), which includes a chain, timing tooth-shaped belt, tooth-shaped belt, so as to be provided for the transmission operations between the bimodal elliptical active wheel (112), the bimodal elliptical passive wheel (213) and the auxiliary wheel (312).

11. A treadle-drive elliptical wheel transmission wheel series with periodically varied speed ratio claimed by claim 1, wherein the active wheel is a bimodal elliptical active gear and the passive wheel is a bimodal elliptical passive gear, which mainly consist of
Bimodal elliptical active gear (114): combined with the active wheel shaft (111), the two sides of the active wheel shaft (111) are respectively combined with a first crank (101) and a second crank (201), the first crank (101) is installed with a first treadle shaft (103) for being provided with a first treadle (102), the second crank (201) is installed with a second treadle shaft (203) for being provided with a second treadle (202), the bimodal elliptical active gear (114) is composed of a gear, and wherein the mechanical angle position between the bimodal of the bimodal elliptic and the active wheel shaft (111) and the mechanical angle position between the first treadle shaft (103) and the second treadle shaft (203) and the active wheel shaft (111) form a certain mechanical angle differentiation relation;
Bimodal elliptical passive gear (214): constituted by a bimodal elliptical gear having the same shape and the same size as the bimodal elliptical active gear (114), and engaged with the bimodal elliptical active gear (114) at a 90 degree mechanical angel differentiation for being driven by the bimodal elliptical active gear (114);
In the transmission wheel series composed of the bimodal elliptical active gear (114) serving as an active wheel, the bimodal elliptical passive gear (214) serving as a passive wheel and the above two components are engaged at a 90 degree mechanical angle differentiation, when a human uprightly treadle to ride a bicycle, the right foot and the left foot follow a simple harmonic motion to form a sine wave treadle track with 180 degree differentiation, wherein the right foot treadles with respect to the up/down displacement track of the first treadle (103), and the left foot treadles with respect to the up/down displacement track of the second treadle shaft (203), and during the continuous treadling of the right foot and the left foot, the speed ratio of the active wheel and the passive wheel of the treadle-drive elliptical transmission wheel series is defined through the relation of the mechanical angle position between the bimodal elliptical active gear (114) and the active wheel shaft (111) and the mechanical angle position between the first treadle shaft (103) and the second treadle shaft (203) and the active wheel shaft (111), and according to the set relation of the mechanical angle differentiations, the bimodal elliptical active gear (114) periodically generates twice increase and decrease of the speed ratio to the bimodal elliptical passive gear (214) during each treadle rotation.

12. A treadle-drive elliptical wheel transmission wheel series with periodically varied speed ratio claimed by claim 11, wherein the mechanical angle differentiation relation of the mentioned bimodal elliptical active gear (114) and the first treadle shaft (103) and the second treadle shaft (203) is selected to be set as, when treadling along the treadle direction, the first treadle shaft (103) or the second treadle shaft (203) passing the upper stop and keeping to treadle along the treadle direction within a 180 degree range, thereby the bimodal elliptical active gear (114) to the bimodal elliptical passive gear (214) is in a transmission varied speed ratio status of tending to the maximum speed accelerating ratio or the minimum speed decelerating ratio.
